(19) United States
(12) Patent Application Publication
(10) Pub. No.: US 2014/0068571 A1
(43) Pub. Date: Mar. 6, 2014

(54) FACILITY

(71) Applicant: SIEMENS AKTIENGESELLSCHAFT, Munich (DE)

(72) Inventors: Michael DECKER, Spardorf (DE); Rainer HAUSER, Nuremberg (DE)

(73) Assignee: SIEMENS AKTIENGESELLSCHAFT, Munich (DE)

(21) Appl. No.: 13/975,622

(22) Filed: Aug. 26, 2013

(30) Foreign Application Priority Data
Aug. 30, 2012 (DE) 102012215379.9

(51) Int. Cl. G06F 9/45

(52) U.S. Cl. CPC G06F 8/40
USPC 717/139

(57) ABSTRACT

A facility is disclosed including a firmware, which calculates at least one electrical variable, having measuring inputs at which analog electrical signals are present, having a hardware controlled by the firmware, and having data with a number of interfaces, which allow for data to be input and output and for communication. It is proposed in an embodiment that the hardware be used as a platform for an application which extends the facility by a functionality and is created as application software, which an interpreter converts into a machine-readable code prior to loading such that a mechanism transmits the code to the facility, such that transmitted application runs in a predetermined environment, which the application cannot leave, and that the application can access data, the inputs and outputs and the communication by way of a programming interface which are permitted by the programming interface to a limited degree.

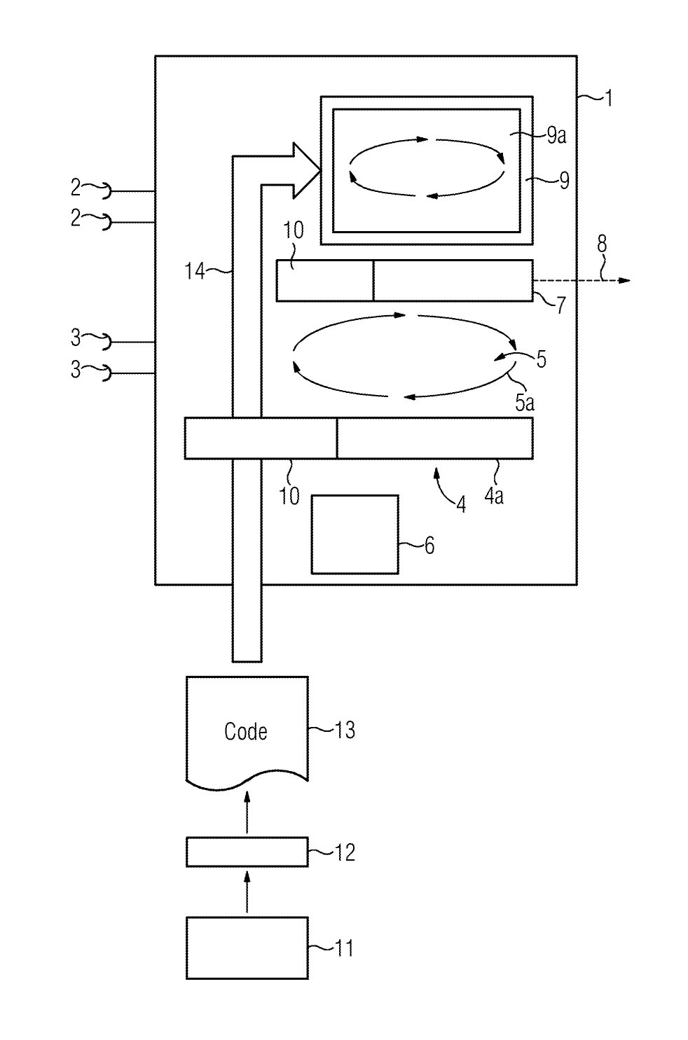

### PRIORITY STATEMENT

The present application hereby claims priority under 35 U.S.C. §119 to German patent application number DE 102012215379.9 filed Aug. 30, 2012, the entire contents of which are hereby incorporated herein by reference.

### FIELD

At least one embodiment of the invention generally relates to a facility.

### BACKGROUND

Facilities for power and quality control of electrical networks are known as PMD (Power Monitoring Device) and PQM (Power Quality Monitoring). These facilities are currently embodied as intelligent measuring devices with current voltage inputs. The currents and voltages are measured and converted into corresponding digital signals by means of AD converters.

The measured values are used by firmware to calculate electrical variables. One of these variables is for instance the electrical power of the network. The calculation takes place by way of hardware having a processor as a central unit, which is controlled by the firmware. Furthermore, the firmware has data, to which the digitalized measured values belong and which are available for further calculations. The facilities in most instances have a number of interfaces, which enable data to be input and output and enable communication with third-party devices and/or third-party systems as well as internal clocks.

To use the hardware for special functionalities specially adjusted firmware variants are required. This is disadvantageous in that each firmware variant has to be extensively tested, thereby being correspondingly expensive.

### SUMMARY

At least one embodiment of the invention extends the PMD/PQM facilities by customer-specific functionalities, without having to provide a plurality of firmware variants.

At least one embodiment provides that the hardware is used as a platform for a further application, which extends the facility by a functionality and is produced as application software in a high level language, and that an interpreter converts the application software into a machine-readable code prior to being loaded, in other words into an otherwise unreadable code or in other words, a machine code. An update mechanism transfers the machine-readable code to the facility. The further application runs in a predetermined environment of the hardware (of the processor), which the application cannot leave.

A protected main system and a subset of resources thus results, which are available for the further application. The further application accesses the data, the inputs and outputs and the communication (with the facility and third-party devices and third-party systems) by way of a programming interface (API Application Programming Interface).

An embodiment of the invention is therefore able to run further applications on a PMD/PQM, without the underlying PMD/PWM basically having to be changed or a number of variants of the PMD/PQM having to be issued. With the provision of corresponding API functions, which enable access to the measured values, the inputs and outputs and the communication, a further application can be easily integrated into a PMD/PQM, with at the same time much simpler programming. The possibility herewith exists of producing given, customer-specific applications, without the basic firmware of the PMD/PQM having to be accessed or special knowledge with respect to the firmware having to be available.

It is furthermore advantageous in an embodimet of the invention, that the further application can be produced in an open language (e.g. LUA). An LUA application can be converted by way of the interpreter from source code into an intermediate code. This only machine-readable code can then be transferred to the PMD/PQM by means of the update mechanism. Furthermore, such LUA applications run in the environment predetermined by the PMD/PQM, which they cannot leave. This thus prevents the further application disturbing the normal operation of the PMD/PQM even if the further application is faulty.

### BRIEF DESCRIPTION OF THE DRAWINGS

The invention is described in more detail below with the aid of an example embodiment.

The sole FIGURE shows a facility 1, which is embodied as a PMD/PQM (Power Monitoring Device/Power Quality Monitoring).

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

An embodiment of the invention is therefore able to run further applications on a PMD/PQM, without the underlying PMD/PWM basically having to be changed or a number of variants of the PMD/PQM having to be issued. With the provision of corresponding API functions, which enable access to the measured values, the inputs and outputs and the communication, a further application can be easily integrated into a PMD/PQM, with at the same time much simpler programming. The possibility herewith exists of producing given, customer-specific applications, without the basic firmware of the PMD/PQM having to be accessed or special knowledge with respect to the firmware having to be available.

It is furthermore advantageous in an embodimet of the invention, that the further application can be produced in an open language (e.g. LUA). An LUA application can be converted by way of the interpreter from source code into an intermediate code. This only machine-readable code can then be transferred to the PMD/PQM by means of the update mechanism. Furthermore, such LUA applications run in the environment predetermined by the PMD/PQM, which they cannot leave. This thus prevents the further application disturbing the normal operation of the PMD/PQM even if the further application is faulty.

The sole FIGURE shows a facility 1, which is embodied as a PMD/PQM (Power Monitoring Device/Power Quality Monitoring). The facility 1 has measuring inputs 2, 3 for analog electrical signals; the measuring input 2 is the input for a current and the measuring input 3 for a voltage. The facility 1 comprises a hardware 4 with a processor 4a, on which a firmware 5a runs.

Data is stored in a memory 6, the data also including the digitalized electrical signals. This data is available to the firmware 5a for calculation purposes, in particular for calculation of the electrical power of an electrical network as special electrical variables. Furthermore, the facility 1 has a number of interfaces 7, in particular for inputting and outputting data and for communication with external devices and systems, which is indicated schematically by the dashed line 8.

Furthermore, the facility 1 comprises an environment 9, in which (an app) as an application 9a runs which cannot leave the environment 9. In other words, the firmware 5a runs on a system which is protected in respect of the application 9a; a part of the resources is made available to the application 9a. The facility 1 also has a programming interface 10 (an application programming interface API), by way of which the application 9a can access data, the inputs and outputs and the communication, i.e. provided these are permitted to a limited degree by the programming interface (API).

To load the application 9a, this is firstly created as application software 11 in a high level language, for instance by a user (customer). An interpreter 12 converts the application software 11 into a machine-readable code 13, which is then loaded into the environment 9 of the hardware and the firmware 5a. The loading is shown schematically by the arrow and symbolizes a corresponding mechanism 14.

An additional functionality required by the user can be realized by way of the application 9a.

There are various functionalities in the energy distribution, which control consumers or system parts with the aid of the calculated electrical variables. One example of this is a blind current controller, which connects or disconnects specific capacitor stages with the aid of a target specification of the cosine-phi and the momentary idle power requirement of an electrical installation. To this end, such a blind current controller has a measuring facility for electrical variables, various digital inputs and outputs and usually terminals for the communication.

A further example of an additional functionality is the control of a power generation system. Here target value specifications are also compared with the current measured values of the electrical network and therefrom control commands are generated for inverters, which are then distributed via a communication link, e.g. the Ethernet.

In addition to these two examples, any other further functionalities (applications) are conceivable, which calculate measured values, times, target values and/or digital signals etc. in order to derive actions therefrom for instance. These are based on the various different interfaces of the PMD/PQM such as communication, digital inputs and outputs, internal clocks and a very powerful measured value acquisition.

What is claimed is:

1. A facility, comprising:
a firmware, configured to acquire measured values and configured to calculate at least one electrical variable with the aid of analog electrical signals;
measuring inputs, at which the signals are present, including a hardware controlled by the firmware for calculating the electrical variables with the aid of digitized signals;
a plurality of interfaces, configured to allow for data to be input and output and for communication, the data including the digital signals and being available to the firmware for calculations, wherein the hardware is used as a platform for an application, which extends the facility by a functionality and is created as application software in a high-level language;
an interpreter, configured to convert the application software into a machine-readable code before being loaded; and
a mechanism, configured to transfer the machine-readable code to the facility, the transferred application being configured to run in an environment of the hardware and firmware, which is restricted by a programming interface, which it cannot leave, wherein the transferred application is configured to access data, the inputs and outputs and the communication which are permitted to a limited degree by the programming interface.

2. A power generation system, comprising the facility of claim 1.
